(19) United States
(12) Patent Application Publication
(10) Pub. No.: US 2009/0181729 A1
(43) Pub. Date: Jul. 16, 2009

(54) DEVICE CASE WITH OPTICAL LENSES

(76) Inventors: Paul P. Griffin, JR., Nasville, TN (US); David M. Reynolds, Mount Juliet, TN (US)

Correspondence Address: HORNKOHL INTELLECTUAL PROPERTY LAW, P.L.L.C, P.O. BOX 210584, NASHVILLE, TN, 37221, US

(21) Appl. No.: 12/348,319

(22) Filed: Jan. 5, 2009

Related U.S. Application Data
(60) Provisional application No. 61/018,970, filed on Jan. 4, 2008.

(51) Int. Cl. H04M 1/00; H04N 5/225; H04N 5/232

(52) U.S. Cl. 455/575.1; 348/340; 348/345; 348/374; 348/E05.024; 348/E05.042

(57) ABSTRACT

A carrying case for a portable electronic device such as a digital music player or mobile telephone having a digital camera includes a lens for modifying an optical input of the digital camera. The lens is positioned on the carrying case to correspond to a location of an input lens of the digital camera when the device is held within the case such that the camera can be used when the device is held by the carrying case. A plurality of lens of preferably mounted on a rotating disc so that a user can select a particular lens having a desired optical effect. Alternatively, a socket can be used to selectively mount a desired lens from a set of lenses. An illuminating LED may also be included on the case exterior to provide a flash for the camera.

### CROSS-REFERENCES TO RELATED APPLICATIONS

The present application claims priority from co-pending Provisional Patent Application No. 61/018,970 entitled “DEVICE CASE WITH OPTICAL LENSES” filed Jan. 4, 2008.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### FIELD OF THE INVENTION

The present invention is directed toward a case for a portable electronic device having a camera that includes a lens for modifying an optical input of the camera when the device is held in the case.

### BACKGROUND OF THE INVENTION

A wide variety of digital electronic devices such as digital music players, cellular telephones, personal computers, data assistants, etc. now have digital cameras included. These are typically low cost cameras that lack the image capabilities of dedicated high end cameras which have a selection of optical lenses. While fully functional cameras having a full selection of lens can be produced, the increased cost and decreased portability do not justify the added functionality for the typical buyer of a device such as a mobile phone or digital music player. In addition, when these camera bearing devices are carried in a carrying case, the lens of the camera is often blocked and the camera nonfunctional. Therefore, in light of the above discussed problems with prior art cases, what is needed is an improved carrying case for a device having a digital camera.

### SUMMARY OF THE INVENTION

An embodiment of the present invention is directed toward a case for an electronic device having a digital camera. The case includes a lens for modifying an optical reception of the camera when the electronic device is positioned in the case. The lens is mounted on a rotating disc having a plurality of lenses. The plurality of lens includes a wide angle, telephoto, fish eye lens and compound lens. A lens for modifying the optical reception of the camera can be selected by rotating the disc.

Another embodiment of the present invention is directed toward a carrying case for a portable electronic device such as a digital music player or mobile telephone having a digital camera that includes a mounting portion for securing the carrying case to the portable electronic device. A lens is positioned on the carrying case to correspond to the location of an input lens of the digital camera when the device is held within the case so that the lens modifies an optical input of the digital camera when the device is held by the carrying case. The lens is removably coupled to the carrying case through a magnetic or threaded socket. The lens can be removed from the case and replaced with one of a plurality of lens. The plurality of lenses includes a wide-angle, close up and telephoto lens. An LED is positioned on the exterior of the case to illuminate the area being photographed.

Yet another embodiment of the present invention is directed toward a case for a mobile telephone having a touch screen on a front face of the mobile telephone and a camera on a back face of the mobile telephone. The case has a back portion having grasping portions attached thereto for removably securing the back portion to the mobile telephone without touching the touch screen of the phone. A rotating disc having a close up optical lens positioned thereon is positioned on the back portion such that it can be rotated to align the close up optical lens with the camera on the back face of the mobile telephone when the mobile telephone is held in the grasping portions so that an optical input of the camera is altered and the camera produces a close up image. A clip on the case allows the case to be connected to the belt of a user in a first position. The clip swivels into a second position to form a stand for the mobile telephone. The case has an opening positioned such that a power supply can be coupled to the mobile telephone when the mobile telephone is secured to the case.

### BRIEF DESCRIPTION OF THE SEVERAL VIEWS OF THE DRAWINGS

FIGS. 1(a) and (b) are front and back views of a device case constructed in accordance with an embodiment of the present invention holding a camera phone;

FIG. 2 is an illustration of a rotating lens disc for a case constructed in accordance with an embodiment of the present invention;

FIG. 3 is an illustration of a device case constructed in accordance with an embodiment of the present invention;

FIGS. 4(a) and (b) are illustrations of a device case constructed in accordance with an embodiment of the present invention; and

FIG. 5 is an illustration of a device case having a sliding lens cover constructed in accordance with an embodiment of the present invention.

### DETAILED DESCRIPTION OF THE INVENTION

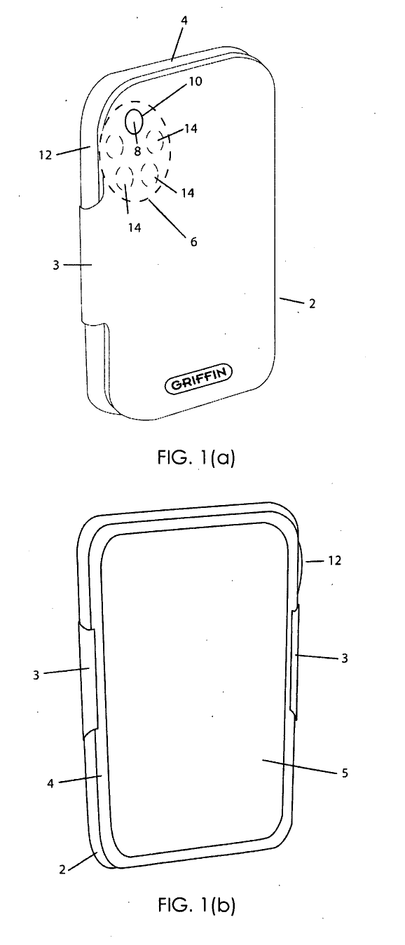

Referring now to FIGS. 1(a) and (b), front and back views of a device case 2 constructed in accordance with an embodiment of the present invention holding a portable electronic device 4 are shown. The case 2 has grasping portions or arms 3 designed to clasp the back of a portable electronic device 4, such as an Apple iPhone, that includes a digital camera. Portions of the case are left open so that the controls of the device 4 can be accessed when the device is held within the case 2. The device 4 has a camera lens 8 positioned on the back. The case 2 has a rotating disc 6 on its back panel that is positioned to partially cover an opening 10 in the back panel of the case 2. The rotating disc 6 may be on the exterior or interior of the case 2. The opening 10 is positioned on the case 2 such that it corresponds to the location of the camera lens 8 of the device 4 when the device is positioned in the case. This is easily accomplished since the case 2 must already be designed to accommodate a particular type or class of device 4. The rotating disc 6 has a gripping surface on its outer circumference and a portion 12 of the rotating disc extends beyond the side of the case to allow a user to grip and rotate the disc 6 with their fingers. The rotating disc 6 is constructed such that it can rotate to position each one of a plurality of optical lenses 14 made of glass or transparent plastic over the opening in the case 2. The lenses 14 of the case 2 each alter the optical input of the device 4 camera in a desired manner to provide the device with optical capabilities lacking in a low cost digital camera as described in more detail herein.

While the embodiment shown in FIGS. 1(a) and (b) is a holster type case 2 that allows the device 4 to be carried on the belt of a user and be quickly removed from the case, the case 2 can be designed with any type of typical device case configuration. For example, the case can be constructed from a hard plastic clam shell type housing that fits together to enclose the device, a burlap or canvas material that forms a pocket for the device or a gripping rubber material that stretches over the exterior of the device. The primary requirement is that the case be able to hold the device such that the camera lens of the device remains aligned with the optical lens of the case. The grasping arms 3 of the case 2 of FIGS. 1(a) and (b) allow the case to be coupled to the device 4 without touching its front face which has a touch screen input 5. However, if a case is designed for a device not having a touch screen, this will not be a consideration.

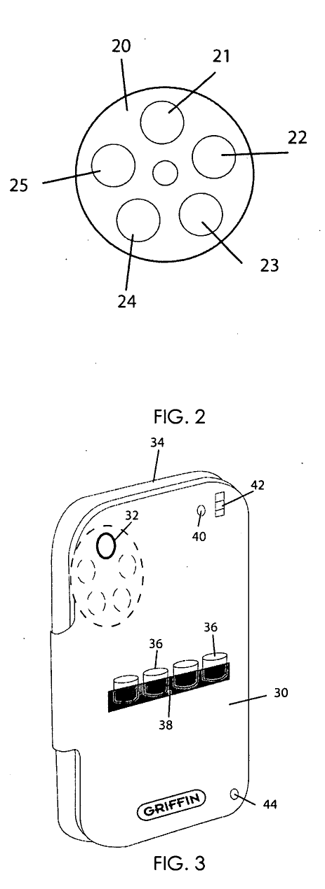

An exemplary rotating lens disc is shown in FIG. 2. The rotating disc 20 has five lenses 21-25 positioned around the circumference of the disc. The first lens 21 is a magnifying lens that provides the device camera with a close up functionality when it is rotated into position over the lens opening of the camera. The second lens 22 is bulge or dent lens that either expands or contracts the center of the image. The third lens 23 is a telephoto lens that provides an increased range for the camera. The fourth lens 24 is a fish eye or wide-angle lens that takes in a wide, hemispherical image. The fifth lens 25 is a clear lens that allows the camera to function in its designed fashioned. An opaque cover can also be included that blocks the opening. The rotating disc 20 preferably snaps into position for each lens 21-25 such that the lens is properly positioned over the opening in the case for the camera lens. The lenses 21-25 can be a simple lenses consisting of a single optical element or a compound lens consisting of an array of optical elements. The use of multiple element lenses allows more optical effects to be achieved than is possible with a single element lens. In addition, an adjustable lens element may be included that can be rotated to selectively alter the compound lenses optical properties. The lenses 21-25 shown in FIG. 2 are exemplary only and any type of suitable lens such as telephoto, night vision, zoom, fisheye, colored, infrared, ultraviolet, swivel, etc. can be included on a case constructed in accordance with the present invention. The lens may also include a marking or logo such that each image taken through the lens bears the given mark.

A slide having a plurality of different lenses can be positioned on the case instead of the rotating disc. In such an embodiment, the slide can be shifted sideways to position the desired lens over the opening in the case.

Referring now to FIG. 3, an illustration of a device case 30 constructed in accordance with another embodiment of the present invention is show. The case 30 has a threaded socket 32 positioned over an opening that corresponds to the location of the camera lens when the device 32 is positioned in the case 34. The threaded socket 32 functions as a lens mount for a plurality of lenses 36 that are preferably held by a pocket 38 on the case 30.

A flash or light 40, such as a light emitting diode (LED), can be provided on the case 30 to illuminate the object being photographed. The light 40 is powered by a battery in the case 30, an external power supply connection 44 on the case or a power coupling between the case and the device 34 that allows the flash light 40 to function in a parasitic manner. The light 40 is activated by a switch 42 or button on the case 30 that allows a user to turn on the light prior to taking a picture. Alternatively, if the case 30 is electrically coupled to the device and a suitable device output is available, the light 40 can be triggered by a signal from the device 34 to only flash when the picture is being taken.

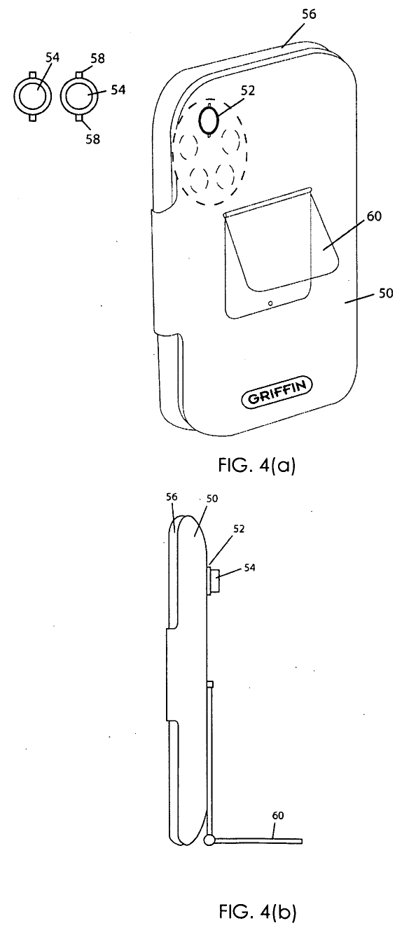

Referring now to FIG. 4, an illustration of a device case 50 constructed in accordance with another embodiment of the present invention is show. The case 50 has a magnetic socket 52 positioned over the camera of the device 56 as described in more detail above. The various lenses 54 have mating magnetic connectors 58 that allow them to be selectively attached to the magnetic socket 52 to provide the desired optical effect. A swivel clip 60 on the case 50 functions to hold the case on the belt of a user. In addition, the clip 58 can swivel to form a stand for the case 50 as shown in FIG. 4(b) that functions as a camera stand for the device 56.

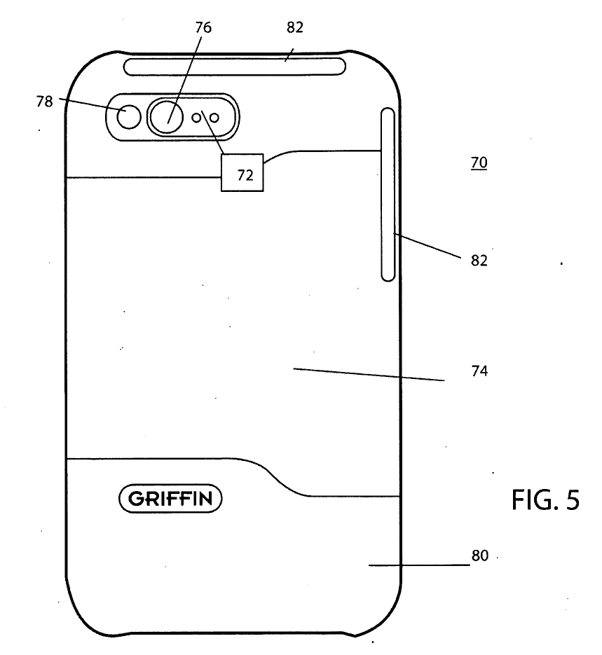

Referring now to FIG. 5, an illustration of an embodiment of the present invention 70 utilizing a sliding lens cover 72 is shown. As discussed above, the protective case body 74 is preferably constructed from a durable polycarbonate with cutaways 82 for access to the power switch, headphone jack, volume controls, and dock connector of the device. The bottom third of the case 80 slides down and off so that the device can be retained in the upper portion of the case when the device is inserted into standard dock wells. A close-up lens 76 on the sliding cover 72 focuses the camera lens 78 close up to allow the camera to be used to capture business cards and document text. The sliding cover 72 slides in place to position the close-up lens 76 over the camera lens 78 for close-ups and then back into its original position such that the camera lens 78 is unobstructed for normal photography.

When the user slides the case lens 76 into place over the built-in lens 78 of the device, the user's close-up shots are instantly finer in detail and more accurate in color. With a properly selected case lens 76, the device can image an entire business card with astounding clarity. In the embodiment of FIG. 5, without the case lens 76 in position, the device requires about 18 inches to focus properly. Once the lens 76 is moved into place, the device can focus to 4 inches with crisp detail for great pictures. The actual increase in performance depends upon the particular lens of the camera and case and the camera's performance.

The case design described herein is further beneficial in that it uses no adapters and has the lens built in and, thus, has no small pieces to lose. Software can be loaded onto the camera equipped device to process the close up images to recognize content and format them for transfer to other types of application software if the camera device is designed to support such features.

1. A carrying case for a portable electronic device having a digital camera, said carrying case comprising:
a lens for modifying an optical input of said digital camera wherein said lens is positioned on said carrying case to correspond to a location of an input lens of said digital camera when said device is held within said case and said digital camera can be used when said device is held by said carrying case.

2. The carrying case of claim 1 wherein said portable electronic device comprises a digital music player or mobile telephone.

3. The carrying case of claim 1 wherein said lens further comprises a plurality of lens that can be selectively positioned to correspond to a location of said input lens.

4. The carrying case of claim 1 wherein said input lens is one of a wide-angle, close up, fish eye or telephoto lens.

5. The carrying case of claim 1 wherein said lens is removably attached to said carrying case through a threaded socket.

6. The carrying case of claim 1 wherein said lens is removably attached to said carrying case through a magnetic connector.

7. The carrying case of claim 6 wherein said carrying case further comprises an illumination light.

8. The carrying case of claim 1 further comprising grasping portions for securing said carrying case to said device.

9. A case for an electronic device having a camera, said case comprising:
a lens for modifying an optical reception of said camera when said electronic device is positioned in said case.

10. The case of claim 9 wherein said lens is mounted on a rotating disc having a plurality of lenses and wherein a lens for modifying said optical reception of said camera can be selected by rotating said disc.

11. The case of claim 9 wherein said lens further comprises a set of lenses that can be removably attached to a threaded socket on said case.

12. The case of claim 9 wherein said lens further comprises a set of lenses that can be removably attached to said case through a magnetic connector on said case.

13. The case of claim 9 wherein said lens is one of a wide angle, telephoto or fish eye lens.

14. The case of claim 9 wherein said lens is a compound lens.

15. A case for a mobile telephone having a touch screen on a front face of said mobile telephone and a camera on a back face of said mobile telephone, said case comprising:
a back portion having grasping portions attached thereto for removably securing said back portion to said mobile telephone without touching said touch screen;
a rotating disc having a close up optical lens positioned thereon wherein said rotating disc is positioned on said back portion such that it can be rotated to align said close up optical lens with said camera on said back face of said mobile telephone when said mobile telephone is held in said grasping portions such that an optical input of said camera is altered and said camera produces a close up image.

16. The case of claim 15 further comprising an illumination light for said camera.

17. The case of claim 15 wherein said rotating disc further comprises one of a non-refracting lens, telephoto or fish eye lens.

18. The case of claim 15 further comprising a clip for mounting said case.

19. The case of claim 18 wherein said clip swivels to form a stand for said mobile telephone.

20. The case of claim 15 further comprising an opening positioned such that a power supply can be coupled to said mobile telephone when said mobile telephone is secured to said case.
